(19) United States
(12) Patent Application Publication
(10) Pub. No.: US 2011/0092150 A1
(43) Pub. Date: Apr. 21, 2011

(54) AIR DISTRIBUTION SYSTEM

(76) Inventor: Jean-Paul Morier, Victorville, CA (US)

(21) Appl. No.: 12/907,894

(22) Filed: Oct. 19, 2010

Related U.S. Application Data
(60) Provisional application No. 61/253,698, filed on Oct. 21, 2009.

(51) Int. Cl. F24F 7/00; F26B 25/00

(52) U.S. Cl. 454/237; 34/86

(57) ABSTRACT

An air distribution system for directing heated air flow emanating or exhausted from a dryer into an area of a house, for increasing the temperature of the area, is provided. The air distribution system includes a housing comprising a top spaced apart from a bottom, and opposing laterally spaced side walls and opposing laterally spaced end walls interconnecting the top and the bottom to define an interior section therein; a pair of openings located in the top and configured to receive a pair of vertical partition members, the pair of vertical partition members extending upwardly from the bottom through the pair of openings in the top defining a plurality of chambers in the interior section; an inlet port located in the bottom for receiving air flow; and a pair of outlet ports located in the opposing laterally spaced end walls for directing the air flow from the interior section.

### CLAIM OF PRIORITY UNDER 35 U.S.C. §119

The present Application for Patent claims priority to U.S. Provisional Application No. 61/253,698 entitled “AIR DISTRIBUTION SYSTEM”, filed Oct. 21, 2009, and hereby expressly incorporated by reference herein.

### FIELD

The present invention relates to an air distribution system for heating an area of a structure, such as a house, with exhaust air flow emanating from an appliance, such as a clothes dryer.

### BACKGROUND

For people who live in a region that is cold in the winter, heating costs take a big bite out of their monthly budget for 25-50% of the year. Due to the rapidly escalating costs of home heating oil, propane, and kerosene, people may be paying twice as much to heat their house as they did just a few years ago. However, current economic pressures have resulted in very little extra money in the average budget for most to pay for these increased costs.

Many methods have been proposed to save on heating costs. For example, some money saving tips include not heating areas of the house that are not used regularly, such as guest rooms, closing heating vents or turning back thermostats in those areas and closing the doors to those rooms. Another option is to turn down the heat and use space heaters to heat the room in which a person spends time or use a programmable thermostat to raise and lower the temperature at pre-set times. All of these methods are helpful and will help save money if properly implemented. However, none of these methods utilize a pre-existing source of heat that is generated by, and exhausted from, existing appliances. As a result, existing heat sources which could supplement typical heating methods are being wasted.

In view of the above, what is needed is an air distribution system to direct heat emanating or exhausted from an appliance, such as a clothes dryer, into an area of a structure, such as a house, to increase the temperature of that area by using a pre-existing heated air flow which would normally be directed outside.

### SUMMARY

An air distribution system for directing exhaust air flow emanating or exhausted from an appliance, such as a dryer, into an area of a structure, such as a room in a house, to increase the temperature of, or heat, that area with the heated exhaust air flow, which would normally be directed outside, is provided. The air distribution system may include a housing comprising a top spaced apart from a bottom, and opposing laterally spaced side walls and opposing laterally spaced end walls interconnecting the top and the bottom to define an interior section therein; a pair of openings located in the top and configured to receive a pair of vertical partition members, the pair of vertical partition members extending upwardly from the bottom through the pair of openings in the top defining a plurality of chambers in the interior section; an inlet port located in the bottom for receiving air flow emanating from the appliance; and a pair of outlet ports located in the opposing laterally spaced end walls for directing the air flow from the interior section to an outlet port.

The plurality of chambers may include a center chamber, a first side chamber and a second side chamber, while the pair of vertical partition members may include at least one of a solid vertical partition member, for preventing the air flow from entering a side chamber and exiting a corresponding outlet port, and a flow directing vertical partition member having a flow directing opening, for allowing exhaust air in the interior of the air distribution system to be directed into the corresponding side chamber and out the corresponding outlet port.

In one aspect, the solid vertical partition member and the flow directing vertical partition member are interchangeable allowing the direction of the air flow to be interchangeable between the first side chamber and the second side chamber. In other words, the heated exhaust air flow may be directed out a specific outlet port.

In another aspect, the exhaust air flow may originate from a clothes dryer and enter the interior of the housing through the inlet port via a flexible dryer duct member. First and second flexible hoses may be connected to the pair of outlet ports in the housing and used to direct the exhaust air flow from the housing into a room in a structure causing the temperature in the room to increase. The air distribution system may be secured to the clothes dryer via one or more attaching members, which include one or more plate members having one end screwed into the housing and the other end screwed into the clothes dryer or other structure.

In yet another aspect, a screen may cover the flow directing opening for preventing debris from exiting out the outlet ports and into the room in which the air flow is being directed.

### BRIEF DESCRIPTION OF THE DRAWINGS

The features, nature, and advantages of the present aspects may become more apparent from the detailed description set forth below when taken in conjunction with the drawings in which like reference characters identify correspondingly throughout.

FIG. 1 illustrates a back perspective view of an air distribution system, according to an embodiment of the present invention.

FIG. 2 illustrates a side perspective view of the air distribution system of FIG. 1.

FIG. 3 illustrates a front perspective view of the air distribution system of FIG. 1.

FIG. 4 illustrates an air distribution system attached to the back of a dryer, according to an embodiment of the present invention.

FIG. 5 illustrates an air distribution system attached to the back of a dryer, according to an embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention.

Embodiments of the invention are directed to an air distribution system for directing heat emanating or exhausted from an appliance, such as a clothes dryer, into an area of a structure, such as a room in a house, to increase the temperature in that area by using the heated air flow which would normally be directed into the atmosphere. In one embodiment, the air distribution system may include a housing comprising a top spaced apart from a bottom, and opposing laterally spaced side walls and opposing laterally spaced end walls interconnecting the top and the bottom to define an interior section therein; a pair of openings located in the top and configured to receive a pair of vertical partition members, the pair of vertical partition members extending upwardly from the bottom through the pair of openings in the top defining a plurality of chambers in the interior section; an inlet port located in the bottom for receiving air flow; and a pair of outlet ports located in the opposing laterally spaced end walls for directing the air flow from the interior section to an outlet port.

While the present invention is described primarily with respect to a clothes dryer, the present invention may be applied and adapted to any type of device which generates a heated exhaust air flow.

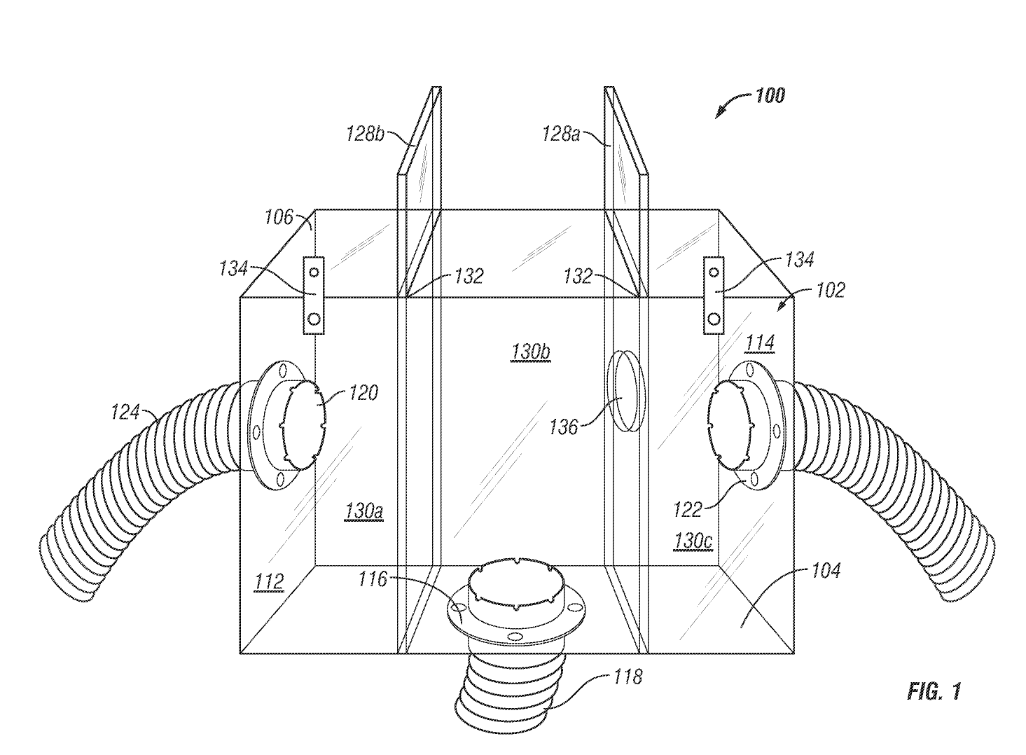

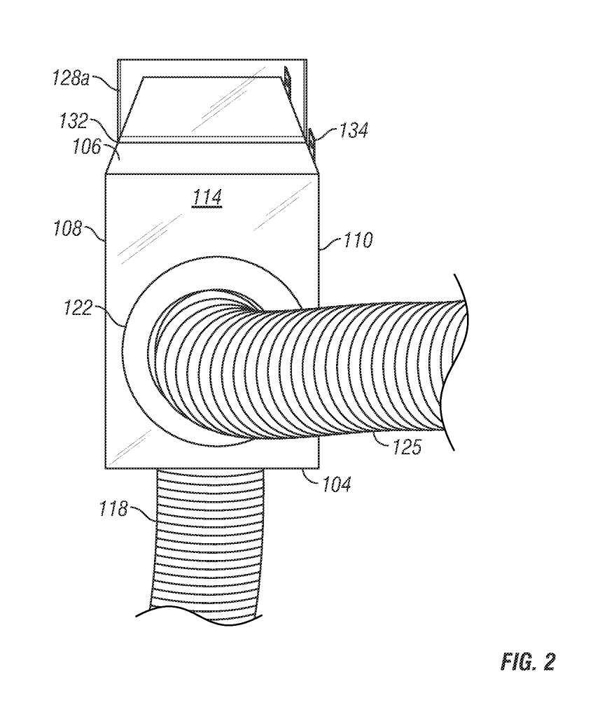

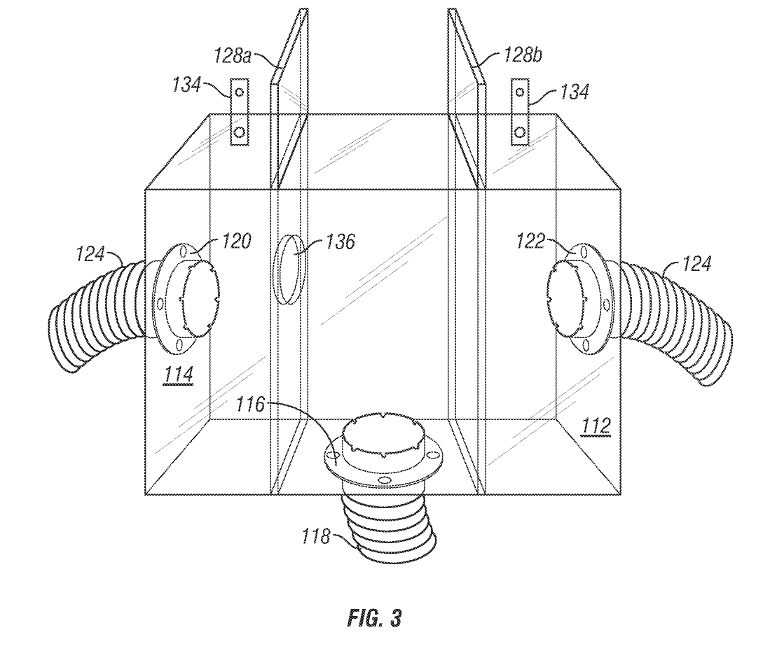

FIG. 1 illustrates a back perspective view of an air distribution system, according to an embodiment of the invention. FIG. 2 illustrates a side perspective view of the air distribution system of FIG. 1. FIG. 3 illustrates a front perspective view of the air distribution system of FIG. 1. The following discussion refers interchangeably to FIGS. 1-3.

As shown, the air distribution system 100 may include a housing 102 having a bottom 104 spaced apart from a top 106, opposing laterally spaced side walls 108 and 110 and opposing laterally spaced end walls 112 and 114. The opposing laterally spaced side walls 108 and 110 and opposing laterally spaced end walls 112 and 114 may be integrally connected to the top 106 and the bottom 104 to define an interior section of the housing 102.

In one embodiment, an inlet port 116 may be situated in the bottom 104 of the housing 100 for receiving air flow or exhaust air flow (hereinafter used interchangeably). Alternatively, the inlet port 116 may be located in one of the opposing laterally spaced side walls 108 and 110. A flexible dryer exhaust duct member 118 may be connected to the inlet port 116 on one end and connected to an exhaust part of a dryer at its opposite end (not shown). The inlet port 116 may be sized to fit within the inside diameter of the flexible dryer duct member 118.

The opposing laterally spaced end walls 112, 114 may include a pair or first and second outlet ports 120 and 122, respectively, for directing the air flow from the interior section of the housing 102 to an outlet port 120 or 122 into a separate area for increasing the temperature in that area. A first flexible hose 124 may be connected to the first outlet port 120 where the first outlet port 120 is sized to fit within the inside diameter of the first flexible hose 124. A second flexible hose 125 may be connected to the second outlet port 120 where the second outlet port 122 is sized to fit within the inside diameter of the second flexible hose 125. The inlet port 116 and the first and second outlet ports 120, 122 may be any type of connector known in the art.

The interior section of the housing 102 may be divided by one or more vertical partition members 128a, 128b defining a plurality of chambers in the interior section, for example a first side chamber 130a, a center chamber 130b and a second side chamber 130c. The vertical partition members 128a, 128b may be inserted into the interior section of the housing 102 through openings 132 located in the top 106 of the housing 102. The openings 132 may be sized to fit the vertical partition members 128a, 128b. When inserted, the vertical partition members 128a, 128b may extend upwardly from the bottom 104 of the housing through the openings 132 in the top 106 such that a portion of the vertical partition members 128a, 128b may extend past the top 106 of the housing 102 allowing the vertical partition members 128a, 128b to be easily removed and switched (or swapped), as discussed below. Insertion of the vertical partition members 128a, 128b into the openings 132 may act as a seal such that air flow entering the interior section of the housing 102 cannot escape out through the openings 132 in the top 106.

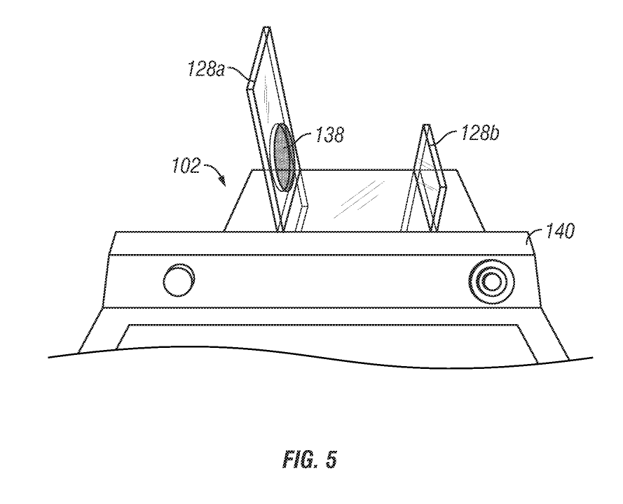

One of the vertical partition members 128a may include a flow directing opening 136 for directing or allowing air flow into the interior section of the housing 102 to escape out of one of the outlet ports 120, 122, while the other vertical partition member 128b may be solid for closing off one of the side chambers in the interior section and preventing the air from escaping out the outlet port associated with the side chamber. As described above, one vertical partition member may define the first side chamber 130a and the center chamber 130b, while the other vertical partition member may define the center chamber 130b and the second side chamber 130c. In one embodiment, the flow directing opening 136 in the vertical partition member 128a may be covered by a screen 138 (See FIG. 5) that allows the exhaust air flow to pass through while preventing lint and other particles or debris emanating from the exhaust air flow from passing through.

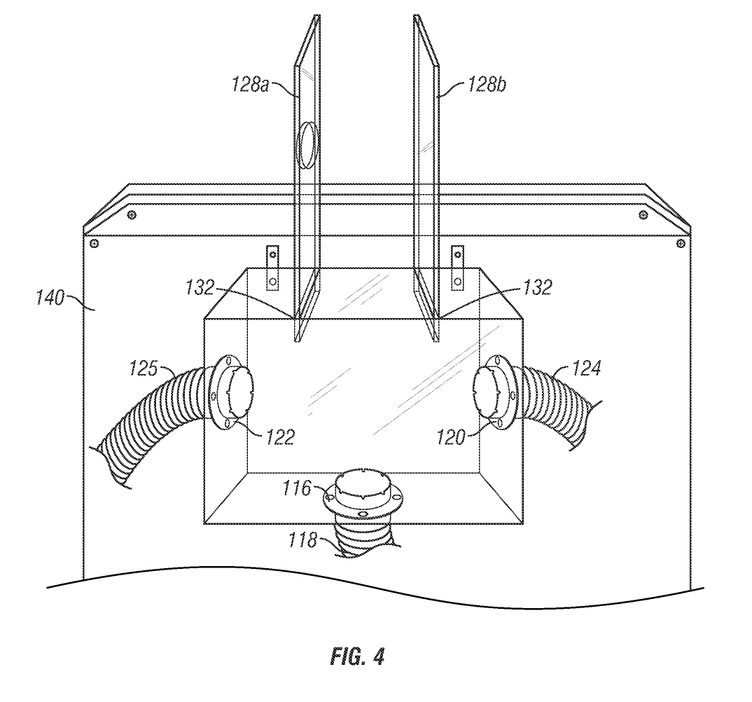

The housing 102 may include one or more attaching members 134 for securing the housing 102 to an appliance 140, such as a clothes dryer, or other structure, such as a wall. (See FIGS. 4-5) The attaching members 134 may include one or more plate members having one end screwed into the housing 102 and the other end screwed into the dryer or other structure. Alternatively, the attaching member 134 may be any type of device or method for securing one object to a second object.

The housing 102 may be mounted on the upper portion of the back of the dryer 140 for allowing a user to easily change or swap the position of the vertical partition members 128 so that the exhaust air can be easily redirected. Specifically, as the top portions of the vertical partition members 128a, 128b may extend beyond the top 106 of the housing, the vertical partition members 128a, 128b may be easily grabbed and removed and swapped (or interchanged) to redirect the exhaust air flow. (See FIG. 5) For example, a solid vertical partition member 128b may be used to define the first side chamber 130a and the center chamber 130b causing the exhaust air flow to be directed out the second side chamber 130c. (See FIG. 3) That is, the air flow may be prevented from entering the first side chamber 130a as the vertical partition member is solid. Conversely, to redirect the exhaust air flow out through the first side chamber 130a, the solid vertical partition may be removed from a first opening which caused it to define the first side chamber 130a and the center chamber 130b and be inserted into a second opening causing it to define the center chamber 130b and the second side chamber 130c. As a result, the exhaust air flow may be easily directed into the first side chamber 130a instead of the second side chamber 130c. This is advantageous as the heated exhaust air flow may be directed from exiting into the house to exiting outside the house and into the atmosphere during summer months. For example, the first flexible hose may direct the exhausted air flow to a separate room in a house while the second flexible hose may direct the exhausted air flow outside and into the atmosphere. In yet another example, the first flexible hose may direct the exhausted air flow to a first room in a house while the second flexible hose may direct the exhausted air flow into a second room in the house.

When drying clothes or other items in a dryer 140, the exhaust air flow from the dryer 140 may be directed to the housing 102 of the air distribution system 100 via the flexible dryer exhaust duct member 118. The exhaust air from the dryer may enter the interior of the housing 102 in the center chamber 130b and then exit the housing 102 via the first side chamber 130a or the second side chamber 130b. The air flow may be directed to either the first or second side chambers 130a, 130c by the vertical partition members 128a, 128b. That is, the vertical partition member 128a having the flow directing opening 136 may allow the exhaust air to pass into the corresponding side chamber and out the corresponding outlet port into a flexible hose.

As discussed above, one end of the flexible hose may be connected to an outlet port of the housing 102 and the other end of the flexible hose may be located in a room different than the room in which the dryer 140 is located so that when the dryer is in use, the heated exhaust air flow may be directed into the room causing the room to heat up without using any other heat source. Consequently, a home owner can save money on heating bills by utilizing the heated exhaust air from a dryer to heat a room instead of directing the heated exhaust air to the outside where it is dispersed in the atmosphere.

In one embodiment, the housing 102 is made of polyimide, polyamide, plexiglass or any other material known in the art that is capable of resisting heat from heated air directed from a dryer.

Although the housing 102 is shown as generally rectangular in shape, this is by way of example only and other shapes, such as square, may be utilized.

One or more of the components and functions illustrated in FIGS. 1-5 may be rearranged and/or combined into a single component or embodied in several components without departing from the invention. Additional elements or components may also be added without departing from the invention. Additionally, the features described herein may be implemented in software, hardware, as a business method, and/or combination thereof.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

1. An air distribution system comprising:
a housing, the housing comprising:
a top spaced apart from a bottom, and opposing laterally spaced side walls and opposing laterally spaced end walls interconnecting the top and the bottom to define an interior section therein;
a pair of openings located in the top and configured to receive a pair of vertical partition members, the pair of vertical partition members extending upwardly from the bottom through the pair of openings in the top defining a plurality of chambers in the interior section;
an inlet port located in the bottom for receiving air flow; and
a pair of outlet ports located in the opposing laterally spaced end walls for directing the air flow from the interior section.

2. The system of claim 1, wherein the plurality of chambers includes a center chamber, a first side chamber and a second side chamber.

3. The system of claim 2, wherein the pair of vertical partition members includes a solid vertical partition member and a flow directing vertical partition member.

4. The system of claim 3, wherein the flow directing vertical partition member includes a flow directing opening for directing the air flow from the center chamber to either the first side chamber or the second side chamber.

5. The system of claim 4, wherein the solid vertical partition member prevents the air flow from entering one of the side chambers.

6. The system of claim 5, wherein the solid vertical partition member and the flow directing vertical partition member are interchangeable allowing the air flow to be interchangeably directed between the first side chamber and the second side chamber.

7. The system of claim 6, wherein the air flow originates from a clothes dryer and enters the chamber through the inlet port.

8. The system of claim 1, further comprising a first flexible hose connected to a first outlet port in the pair of outlet ports and a second flexible hose is connected to a second outlet port in the pair of outlet ports.

9. The system of claim 8, wherein the first flexible hose directs the air flow into a room in a structure causing the temperature in the room to increase.

10. The system of claim 8, wherein the second flexible hose directs the air flow to a location outside the structure for dispersing into the atmosphere.

11. The system of claim 1, wherein the housing is made of a heat resistant material.

12. The system of claim 1, further comprising one or more attaching members for securing the housing to a clothes dryer.

13. The system of claim 4, further comprising a screen covering the flow directing opening for preventing debris from exiting out the pair of outlet ports.

14. The system of claim 1, wherein top portions of the pair of vertical partition members extend beyond the top of the housing.

15. An air distribution system comprising:
a housing, the housing comprising:
a top spaced apart from a bottom, and opposing laterally spaced side walls and opposing laterally spaced end walls interconnecting the top and the bottom to define an interior section therein;
a pair of openings located in the top and configured to receive a pair of vertical partition members, the pair of vertical partition members extending upwardly from the bottom through the pair of openings in the top defining a plurality of chambers in the interior section;
an inlet port located in the bottom for receiving air flow; and
a pair of outlet ports located in the opposing laterally spaced end walls for directing the air flow from the interior section; and
a first flexible hose connected to a first outlet port in the pair of outlet ports and a second flexible hose is connected to a second outlet port in the pair of outlet ports, the first flexible hose directs the air flow into a room in a structure causing the temperature in the room to increase and the second flexible hose directs the air flow to a location outside the structure for dispersing into the atmosphere.

16. The system of claim 15, wherein the plurality of chambers includes a center chamber, a first side chamber and a second side chamber.

17. The system of claim 16, wherein the pair of vertical partition members includes a solid vertical partition member and a flow directing vertical partition member.

18. The system of claim 17, wherein the flow directing vertical partition member includes a flow directing opening for directing the air flow from the center chamber to either the first side chamber or the second side chamber.

19. The system of claim 17, further comprising a screen covering the flow directing opening for preventing debris from exiting out the pair of outlet ports.

20. The system of claim 17, wherein the solid vertical partition member and the flow directing vertical partition member are interchangeable allowing the air flow to be interchangeably directed between the first side chamber and the second side chamber.
